(19) United States
(12) Patent Application Publication
(10) Pub. No.: US 2020/0308453 A1
(43) Pub. Date: Oct. 1, 2020

(54) WATER-DISPERSIBLE SHEET

(71) Applicants: NIPPON PAPER PAPYLIA CO., LTD., Shizuoka (JP); Nippon Paper Industries Co., Ltd., Tokyo (JP)

(72) Inventors: Masaki Kishimoto, Tokyo (JP); Yoshiaki Ishino, Tokyo (JP); Yasuaki Matsumori, Tokyo (JP)

(21) Appl. No.: 16/756,402

(22) PCT Filed: Nov. 29, 2018
(86) PCT No.: PCT/JP2018/043941

§ 371 Date: Apr. 15, 2020

(30) Foreign Application Priority Data
Dec. 25, 2017 (JP) 2017247603

(51) Int. Cl. C09J 7/29; D21H 27/00; D21H 15/10; D21H 17/26; C09J 7/21; B41M 5/41

(52) U.S. Cl. CPC C09J 7/29; D21H 27/00; D21H 15/10; D21H 17/26; C09J 2205/106; B41M 5/41; C09J 2203/334; C09J 2400/28; C09J 7/21

(57) ABSTRACT

A water-dispersible sheet with improved water dispersibility is provided. Provided is paper-making fibers containing two kinds of compounds, a specific alkalized fibrous carboxyalkyl cellulose and a specific carboxyalkyl cellulose salt. That is a water-dispersible sheet comprising a papermaking fiber and an alkalized fibrous carboxyalkyl cellulose and further comprising a carboxyalkyl cellulose salt, wherein the degree of etherification of the fibrous carboxyalkyl cellulose is 0.2 to 0.6, the degree of etherification of the carboxyalkyl cellulose salt is 0.5 to 1.6, the viscosity of 1% aqueous solution of the carboxyalkyl cellulose salt measured by Brookfield viscometer is 2 to 200 mPa-s, and the ratio of the carboxyalkyl cellulose salt to the sum of the papermaking fibers and the alkalized fibrous carboxyalkyl cellulose is 0.1 to 10% by weight.

### FIELD OF THE INVENTION

The present invention relates to a water-dispersible sheet with an improved water dispersibility, and more particularly to a water-dispersible sheet comprising a tacky adhesive layer on one of the surfaces and a coating layer, such as a thermosensitive recording layer or an inkjet recording layer, on the other surface.

### BACKGROUND OF THE INVENTION

Water-dispersible paper (also referred to as water-disintegrable paper or water-soluble paper), which is rapidly dispersed in water, is widely used for applications such as filter-wrapping paper of cigarettes, wrapping paper, confidential document paper, water-dispersible labels (References 1, 2 etc.). As one of these, a water-dispersible label has a structure in which a coating layer such as a thermosensitive recording layer or an ink-jet recording layer is installed on one of the surfaces of the water-dispersible paper, and a water-soluble tacky adhesive layer is installed on the opposite surface, which is being used by attached to a returnable container and the like (Reference 3, etc.).

As the water-dispersible paper such as water-dispersible labels becomes used more widely, better water dispersibility has been required than before.

### REFERENCES

Reference 1: Japanese Patent Application Public Disclosure No. H09-49188

### Reference 2: Japanese Patent Application Public Disclosure No. 2000-170100

### Reference 3: Japanese Patent Application Public Disclosure No. 2004-314623

### Problems to be Solved by the Invention

As a result of examining the conventional water-dispersible paper of the present applicant (References 1 and 2), it was found that the water dispersibility is not sufficient (see Comparative Example 5), although a water-soluble polymer (ex. carboxymethyl cellulose salt) is used as in the present invention, because a water-soluble polymer with high molecular weight (therefore, high viscosity) is used in order to control the air permeability by making the surface of the water-dispersible base material more dense (Reference 1, [0039]) or to make the surface of the base paper hydrophilic (Reference 2, [0017]).

Therefore, an object of the present invention is to provide a water-dispersible sheet having further improved water dispersibility.

### Means to Solve the Problems

Carboxyalkyl cellulose derived from cellulose fiber (i.e. pulp) includes those that retain their fibrous form without much modification and those that is modified advancedly to become powdery. The former is called “fibrous carboxyalkyl cellulose”, and the latter is generally called carboxyalkyl cellulose. In the present invention, the latter is called a “carboxyalkyl cellulose salt”, which does not contain fibrous carboxyalkyl cellulose. In both materials, those in which the carboxyalkyl group is an acid type is water-insoluble, while those in which the carboxyalkyl group is a salt type is water-soluble. In general, the carboxyalkyl cellulose salt is used in applications where a thickening effect or tacky adhesive effect is required when dissolved in water, while the fibrous carboxyalkyl cellulose is used for the production of water-dispersible paper together with pulps, since it has has properties close to the property of a pulp derived from its fiber form.

The degree of etherification of this fibrous material (i.e. fibrous carboxyalkyl cellulose) is generally maintained low for papermaking (ex. about 0.4 to 0.5 of degree of etherification). Powdered material (i.e. carboxyalkyl cellulose salts) with variously modified molecular weights (related to viscosity) and degree of etherification is used depending on the application. For example, a high molecular weight (hence high viscosity) is conventionally used for a water-dispersible paper (Reference 1 and 2), while the degree of etherification has not been sufficiently studied.

In the present invention, fibrous carboxyalkyl cellulose was mixed with papermaking fibers to prepare a papermaking raw material, wherein the fibrous carboxyalkyl cellulose has a low degree of etherification so as to increase the water dispersibility of papermaking fibers, which is favorable for papermaking, and a carboxyalkyl cellulose salt with optimized degree of etherification and viscosity (i.e. low viscosity) was further added to this papermaking raw material, as a result, the water dispersibility of the water-dispersible sheet could be greatly improved.

That is, a carboxyalkyl cellulose salt was added to the water-dispersible sheet comprising papermaking fiber and alkalized fibrous carboxyalkyl cellulose, then the degree of etherification of the fibrous carboxyalkyl cellulose was set to a specific range, and the viscosity of the carboxyalkyl cellulose salt was set to a specific range, and further the content of the carboxyalkyl cellulose salt was set to a specific range, then it was found that the water dispersibility of thus prepared water-dispersible sheet could be further improved, thereby the present invention was completed.

That is, the present invention provides a water-dispersible sheet comprising a papermaking fiber and an alkalized fibrous carboxyalkyl cellulose and further comprising a carboxyalkyl cellulose salt, wherein the degree of etherification of the fibrous carboxyalkyl cellulose is 0.2 to 0.6, the degree of etherification of the carboxyalkyl cellulose salt is 0.5 to 1.6, the viscosity of 1% aqueous solution of the carboxyalkyl cellulose salt measured by Brookfield viscometer is 2 to 200 mPa-s, and the ratio of the carboxyalkyl cellulose salt to the sum of the papermaking fibers and the alkalized fibrous carboxyalkyl cellulose is 0.1 to 10% by weight.

### DETAILED DESCRIPTION OF THE INVENTION

The water-dispersible sheet of the present invention comprises a base material (hereinafter also referred to as “base paper”) and the base material comprises a papermaking fiber, an alkalized fibrous carboxyalkyl cellulose and a carboxyalkyl cellulose salt.

The papermaking fibers used in the present invention includes wood pulp fibers or non-wood pulp fibers commonly used for papermaking, for example, wood pulp fibers such as softwood Kraft pulp, hardwood Kraft pulp, dissolving pulp, mercerized pulp; non-wood pulp fibers such as flax pulp, Manila hemp pulp, Kenaf pulp; purified cellulose fibers such as lyocell, and the like.

The average fiber length of the water-dispersible papermaking fibers is 0.1 to 5 mm, preferably 0.5 to 3 mm, more preferably 0.8 to 2 mm.

The Canadian standard freeness of the papermaking fiber is 200 to 750 ml CSF, preferably 350 to 720 ml CSF, more preferably 500 to 700 ml CSF. The Canadian standard freeness is measured according to Japanese Industrial Standard (JIS) P8121-2 2012 (the same shall apply hereinafter).

As the beating proceeds (the freeness decreases), fibrillation, cutting and internal swelling of the fibers increase. Therefore, the water dispersibility decreases, while the density, strength and smoothness of the base paper increase.

The content of the papermaking fiber in the base paper of the present invention is preferably 20 to 95% by weight, more preferably 30 to 90% by weight, further preferably 40 to 80% by weight.

The fibrous carboxyalkyl cellulose used in the present invention is obtained by carboxyalkylation of natural cellulose fibers, regenerated cellulose fibers or purified cellulose fibers by a known method, and is water insoluble. The examples of the fibrous carboxyalkyl cellulose includes fibrous carboxymethyl cellulose, fibrous carboxyethyl cellulose and the like.

The degree of etherification (hereinafter also referred to as “DS”) of the fibrous carboxyalkyl cellulose is 0.2 to 0.6, preferably 0.4 to less than 0.6 (i.e 0.4 or more and less than 0.6). The degree of etherification refers to the degree of substitution of carboxyalkyl group of the fibrous carboxyalkyl cellulose. If the degree of etherification is low, for example, lower than 0.2, the water solubility is poor, while if the degree of etherification is high, for example, higher than 0.6, the sticking to the wire during papermaking of the base paper etc. happens to make the production difficult. Therefore, in the present invention, fibrous carboxyalkyl cellulose having such a degree of etherification is used.

In the present invention, the fibrous carboxyalkyl cellulose is alkalized by using an alkalizing agent. By alkalizing the base paper, the water-insoluble fibrous carboxyalkyl cellulose in the base paper is converted to a water-soluble fibrous carboxyalkyl cellulose salt by a neutralization reaction, then the fibers of the base paper tend to swell and break up in water and the base paper becomes water dispersible.

The alkalizing agent is an aqueous solution of an alkaline compound, and the specific examples thereof include water solutions of alkali metal hydroxides such as sodium hydroxide and potassium hydroxide; carbonates and bicarbonates of alkali metals such as sodium carbonate and sodium bicarbonate; hydroxides of alkaline earth metals such as calcium hydroxide; ammonia and ammonium salts; amines such as ethanolamine; polyethyleneimine with a molecular weight of 1000 or less; and the like.

The alkalization may be carried out by mixing the alkalizing agent into a stock solution during paper making of base paper, or, after paper making, by spraying the alkalizing agent by using a sprayer, coating by using a coating machine, or transferring the alkalizing agent to the paper stock by using a felt, etc. on which the alkalizing agent is applied, and the like. It can be carried out by any suitable method as appropriate.

The viscosity of the carboxyalkyl cellulose salt used in the present invention is preferably in a specific range, in order to improve the water dispersibility of the water-dispersible sheet of the present invention (particularly, the water dispersible paper with a tacky adhesive layer). That is, the viscosity of a 1% aqueous solution of the carboxyalkyl cellulose salt measured by a Brookfield viscometer is 2 to 200 mPa·s, preferably 2 to 100 mPa·s. If this viscosity is too high, a film is formed on the surface of the water-dispersible sheet and the water penetration becomes worse, then the water-dispersibility is deteriorated.

The carboxyalkyl cellulose salt refers to a carboxyalkyl cellulose in which the carboxyalkyl group is converted to a salt by an alkali metal such as sodium or potassium.

Among these, a carboxymethyl cellulose salt is preferably used, as the carboxyalkyl cellulose salt of the present invention, from the viewpoint of improving water dispersibility and improving strength.

The degree of etherification (DS) of this carboxyalkyl cellulose salt is 0.5 to 1.6, preferably 0.6 to 1.0 (i.e. 0.6 or more and 1.0 or less). The higher the degree of etherification of the carboxyalkyl cellulose salt, for example, about 0.5 to 1.6, the better the water solubility.

In the present invention, the degree of etherification of the fibrous carboxyalkyl cellulose is preferably lower than the degree of etherification of the carboxyalkyl cellulose salt.

The ratio of the carboxyalkyl cellulose salt to the sum of the papermaking fibers and the alkalized fibrous carboxyalkyl cellulose is 0.1 to 10% by weight, preferably 0.5 to 7% by weight. If the ratio of the carboxyalkyl cellulose salt is too high, a film is formed on the surface of the water-dispersible sheet and the water penetration becomes worse, then the water-dispersibility is deteriorated.

The addition of the carboxyalkyl cellulose salt may be conducted by any suitable method as appropriate, for example, by mixing the carboxyalkyl cellulose salt with the stock solution during the paper making of the base paper, or by coating by using a coating machine, or by transferring to the paper stock by using a felt, etc.

The water-dispersible sheet of the present invention can be produced by the following method:

(1) preparing a sheet with a papermaking raw material comprising papermaking fibers and fibrous carboxyalkyl cellulose, and

(2) applying an alkalinizing agent on the papermaking raw material obtained in step (1), and (3) applying a carboxyalkyl cellulose salt on the papermaking raw material obtained in step (2)

or

(2 ‘) applying a carboxyalkyl cellulose salt on the papermaking raw material obtained in step (1); and (3’) applying an alkalinizing agent on the papermaking raw material obtained in the step (2′).

The steps (2) and (3) are performed simultaneously, or the steps (2 ‘) and (3’) are performed simultaneously. That is, the water-dispersible sheet of the present invention can be produced by the following method:

(1) preparing a sheet with a papermaking raw material comprising papermaking fibers and fibrous carboxyalkyl cellulose, and (2″) applying a carboxyalkyl cellulose salt and an alkalinizing agent on the papermaking raw material obtained in step (1).

In the case of coating the alkalizing agent and/or a carboxyalkyl cellulose salt on a base paper, the alkalizing agent and/or a carboxyalkyl cellulose salt may be applied as an aqueous solution of these compounds or the mixed solution of the aqueous solution and an aqueous organic solvent compatible with the aqueous solution, by using a coating machine, such as two-rolls coater such as size press, transfer roll coater, air knife coater, bar coater, spray coater, blade coater, curtain coater, champerex coater, gravure coater or the like.

The coating amount of the alkaline compound is preferably equal to or greater than the equivalent to neutralize the fibrous carboxyalkyl cellulose in the base paper, more preferably 1 to 3 times the neutralization equivalent. If the amount of the alkaline compound is less than the neutralization equivalent, water insoluble fibrous carboxyalkyl cellulose remains, then it becomes difficult to obtain sufficient water dispersibility, and the solubility is greatly reduced since the carboxyalkyl celluloses are bonded with each other over time. In addition, if the amount of the alkaline compound exceeds 3 times the neutralization equivalent, it is not preferable because changes in the appearance and material occurs such as discoloration, strength reduction, etc. of the base paper due to the influence of the alkaline compound remaining in the base paper.

The content of the alkaline compound in the base paper varies depending on the basic weight of the base paper, the degree of substitution and the content of the fibrous carboxyalkyl cellulose, the type of the alkaline compound to be used, and the like, and is desirably appropriately adjusted. By way of example, when the alkaline compound is sodium carbonate, the content of the alkaline compound is 0.3 to 67% by weight based on the weight of the base paper, and when the alkaline compound is sodium hydroxide, the content is 2 to 51% by weight.

The basis weight of the base paper of the present invention is usually 10 to 200 g/m² and, in particular, the base paper of the coated paper for printing/recording is usually 50 g/m² or more, preferably 50 to 120 g/m².

The water-dispersible sheet of the present invention may have a tacky adhesive layer on one of the surfaces.

As the tacky adhesive composing the tacky adhesive layer, a tacky adhesive having water-solubility or water re-dispersibility, particularly a water-soluble acrylic tacky adhesive is suitably used.

Examples of the water-soluble acrylic tacky adhesive include those containing, as a base polymer, those comprise a copolymer comprising alkoxyalkyl acrylate and styrene sulfonate and other copolymerizable monomer, or a copolymer of a carboxyl group-containing vinyl monomer such as (meth) acrylic acid and a hydroxyl group-containing monomer and optionally other copolymerizable monomer, and the like. Examples of the water re-dispersible acrylic tacky adhesive include those containing, as a base polymer, those comprise a copolymer of an alkyl (meth) acrylate ester, a carboxyl group-containing vinyl monomer, a vinyl monomer having an alkoxy group, and optionally other copolymerizable monomer, or a copolymer obtained by copolymerization of carboxylated rosin ester-containing vinyl monomer, carboxyl group-containing vinyl monomer and water soluble vinyl monomer, and the like. The carboxyl group of these copolymers may be in the form of a salt in which a part or the whole thereof is neutralized with an alkali as necessary, in which alkali metal salts, amine salts and alkanolamine salts are preferable as the alkali.

A crosslinking agent may be added to the water-soluble acrylic tacky adhesive in order to adjust the adhesion strength, water solubility or water dispersibility. Such crosslinking agent is not particularly limited, but arbitrary ones can be appropriately selected from those conventionally used as crosslinking agents in acrylic tacky adhesives. Examples the crosslinking agent include, for example, isocyanate crosslinking agent such as 1,2-ethylene diisocyanate, epoxy type crosslinking agent such as diglycidyl ether, melamine resins, urea resins, dialdehydes, methylol polymers, metal chelate compounds, metal alkoxides, metal salts and the like. A conventionally known plasticizer, tacky adhesive, colorant, thickener, defoaming agent, leveling agent, plasticizer, antifungal agent, antioxidant and the like may be added to the acrylic tacky adhesive in order to adjust the properties as necessary and to improve the performance. The plasticizer and the tacky adhesive are preferably water-soluble or water-dispersible. Examples of the plasticizer include polyhydric alcohols such as sugar alcohols, polyether polyols, alkanolamine salts of oxidized rosin, and the like. And examples of the tacky adhesive include alkali metal salts such as rosin, disproportionated rosin and hydrogenated rosin, ammonium salts, polyether esters and the like.

These tacky adhesives may be (i) directly applied on the surface of the base paper on which the alkalizing agent and/or a carboxyalkyl cellulose salt was coated, or (ii) applied on the release agent containing surface of the release sheet to form a tacky adhesive layer, which is then adhered to the surface of the base paper on which the alkalizing agent and/or a carboxyalkyl cellulose salt was coated to transfer the adhesive layer to the surface of the base paper. In either case, a release sheet may be pasted on the adhesive layer and peeled off at the time of use as desired, in order to prevent unnecessary adhesion at times other than use. The coating amount (solid content) of the tacky adhesive layer formed is about 3 to 60 g/m², preferably about 10 to 50 g/m². When the tacky adhesive coating amount is less than 5 g/m², the formed tacky adhesive sheet is insufficient in tacky adhesiveness. On the other hand, when the tacky adhesive coating amount exceeds 60 g/m², the tacky adhesive easily protrudes during production of the tacky adhesive sheet or in a post-processing step, which is not preferable.

The release sheet is not particularly limited and conventionally known release sheet may be used, for example, paper base materials such as glassine paper, coated paper, cast coated paper; laminated paper obtained by laminating thermoplastic resins such as polyethylene etc. on these base paper materials; or various plastic films such as polyethylene terephthalate, polypropylene, polyethylene and the like, on whose one side or both sides release agent such as silicone resin are applied. The basic weight of the release sheet is not particularly limited, but it is usually about 20 to 120 g/m².

The application of the tacky adhesive may be carried out by a printing method and the tacky adhesive may be applied in a pattern shape excluding an edge portion and the like. And the release sheet used in this case may also be partially coated with a release agent corresponding to the pattern shape of the tacky adhesive. Furthermore, a release agent is partially applied on one side of the water-dispersible sheet of the present invention in a dot-like or rectangular discontinuous pattern, while the tacky adhesive is partially applied in a pattern corresponding to the pattern of the release agent on the surface opposite to the surface on which the release agent is applied, then the adhesive applied surface and the release agent applied surface are overlapped to be able to prepare a tacky adhesive sheet that does not require a release sheet.

Arbitrary coating layers such as aqueous coating layer, thermosensitive recording layer or inkjet recording layer may be installed on the other side of the water-dispersible sheet of the present invention, opposite to the tacky adhesive layer, depending on the application.

The coating layer in the present invention may be a single layer or a multilayer as long as it is formed by coating and drying aqueous coating materials, and the coating method is not limited. In addition, the components of the coating layer may be appropriately chosen from those suitable for the coating or printing method (offset printing, gravure printing, inkjet printer, thermal printer, laser beam printer, etc.).

Examples of the coating layers suitable for thermal printers, inkjet printers, and gravure printing are shown below.

(I) Example of Coating Layer (Thermosensitive Recording Layer) Suitable for Thermal Printers:

In order to adapt the water-dispersible sheet of the present invention to printing with a thermal printer, a thermosensitive recording layer containing, as main components, a colorless or pale electron donating leuco dye (henceforth referred to as “leuco dye”) and an electron accepting color developing agent (henceforth referred to as “color development agent”) is installed on the other side of the water-dispersible sheet, opposite to the tacky adhesive layer. An undercoat coating layer comprising a pigment and a binder as main components may be installed between the base paper and the thermosensitive recording layer. Since the base paper has a porous layer (with high heat insulating effect) containing fibrous carboxyalkyl cellulose, the debris forming and the sticking properties are improved.

The smoothness of the surface of the base paper on which the undercoat layer is installed is not particularly limited, but in general, a highly smooth surface is preferred, and a Yankee dryer contacted surface and a calendaring treated surface are suitably used.

The undercoat layer is installed to enhance the smoothness of the surface of the base paper and achieve sharpness and high sensitivity of the image in the thermosensitive recording medium. Any known pigments, binders and various additives are properly selected to be used for the undercoat layer. It is preferable to install the undercoat layer, because, without the undercoat layer, the thermosensitive recording layer contacts directly with the base paper containing the alkalizing agent and/or the carboxyalkyl cellulose salt then the coloring sensitivity of the thermosensitive recording layer may be lowered.

As the pigment for the undercoat layer, inorganic pigments such as silica, calcium carbonate, clay, kaolin, calcined kaolin, diatomaceous earth, talc, titanium oxide, aluminum hydroxide, magnesium carbonate, zinc oxide, aluminum oxide, magnesium hydroxide, barium sulfate, calcium sulfate, zinc sulfate, calcium silicate, aluminum silicate, magnesium silicate, sodium aluminosilicate and magnesium aluminosilicate and the like, or organic pigments such as melamine resin pigment, urea-formalin resin pigment, polyethylene powder, nylon powder and the like may be mentioned.

As the binder of the undercoat layer, water-soluble resins and water-dispersible resins are preferable, the example include starches, hydroxyethyl cellulose, methylcellulose, carboxymethyl cellulose salt, gelatin, casein, sodium alginate, polyvinyl alcohol, modified polyvinyl alcohol, polyvinyl pyrrolidone, polyacrylamide, acrylamide/acrylate copolymer, styrene/maleic anhydride copolymer and alkali salt thereof, ethylene/maleic anhydride copolymer and alkali salt thereof, sodium polyacrylate and the like. Among them, from the viewpoint of water dispersibility, it is desirable to use water-soluble resins such as starch, hydroxyethyl cellulose, methyl cellulose, carboxymethyl cellulose salt, gelatin, casein, sodium alginate, polyvinyl alcohol, modified polyvinyl alcohol, polyvinyl pyrrolidone as the main component of the binder.

The amount (solid content) of the binder in the undercoat layer is usually 5 to 100 parts by weight per 100 parts by weight of the pigment.

In addition to the pigment and the binder, commonly used various additives may be used for the undercoat layer. Examples of the various additives include pigment dispersants, defoaming agents, lubricants, UV absorbers, sizing agents, sensitizers, fluorescent dyes, preservatives, and the like.

The undercoat layer may be obtained by applying the coating material obtained by dispersing and mixing the pigment and the binder with other additives in one layer or multi-layers by using a coating machine then drying by heating it by using a dryer or the like.

The coating amount (solid content) of the undercoat layer is usually 0.5 to 50 g/m², preferably 3 to 15 g/m². Examples of the coating machine include air knife coater, bar coater, roll coater, blade coater, curtain coater, champlex coater, gravure coater etc.

As the leuco dyes used for the thermosensitive recording layer of the present invention, any known leuco dyes can be used solely or in combination of two or more, and in particular, leuco compounds of dye such as triphenylmethane type, fluoran type, phenothiazine type, auramine type, spiropyran type, indolinophthalide type and the like are preferably used. Examples of the leuco dyes include 3,3-bis(p-Dimethyl aminophenyl)-phthalide, 3,3-bis(p-Dimethyl aminophenyl)-6-dimethylaminophthalide [alternate name: crystal violet lactone], 3,3-bis(p-Dimethyl aminophenyl)-6-diethylaminophthalide, 3,3-bis(p-Dimethyl aminophenyl)-6-chlorophthalide, 3,3-bis(p-Dibuthyl aminophenyl)-phthalide, 3-cyclohexylamino-6-chlorofluoran, 3-dimethylamino-5,7-dimethylfluoran, 3-diethylamino-7-chlorofluoran, 3-diethylamino-7-methylfluoran, 3-diethylamino-7,8-benzfluorane, 3-diethylamino-6-methyl-7-chlorofluoran, 3-(N-p-tolyl-N-ethylamino)-6-methyl-7-anilinofluoran, 3-pyrrolidino-6-methyl-7-anilinofluoran, 2-{N-(3′-trifluoromethylphenyl) amino}-6-diethylaminofluoran, 2-{3,6-bis(diethylamino)-9-(o-chloroanilino)xanthylbenzoic acid lactam}, 3-diethylamino-6-methyl-7-(m-trichloromethylanilino) fluoran, 3-diethylamino-7-(o-chloroanilino) fluoran, 3-di-n-butylamino-7-(o-chloroanilino) fluoran, 3-N-methyl-N, n-amylamino-6-methyl-7-anilinofluoran, 3-N-methyl-N-cyclohexylamino-6-methyl-7-anilinofluoran, 3-diethylamino-6-methyl-7-anilinofluoran, 3-(N, N-diethylamino)-5-methyl-7-(N, N-dibenzylamino) fluoran, Benzoyl leuco methylene blue, 6′-chloro-8′-methoxy-benzoindolino-spiropyran, 6′-bromo-3′-methoxy-benzoindolino-spiropyran, 3-(2′-hydroxy-4′-dimethylaminophenyl)-3-(2′-methoxy-5′-chlorophenyl) phthalide, 3-(2′-hydroxy-4′-dimethylaminophenyl)-3-(2′-methoxy-5′-nitrophenyl) phthalide, 3-(2′-hydroxy-4′-diethylaminophenyl)-3-(2′-methoxy-5′-methylphenyl) phthalide, 3-(2′-methoxy-4′-dimethylaminophenyl)-3-(2′-hydroxy-4′-chloro-5′-methylphenyl) phthalide, 3-(N-ethyl-N-tetrahydrofurfuryl) amino-6-methyl-7-anilinofluoran, 3-N-ethyl-N-(2-ethoxypropyl) amino-6-methyl-7-anilinofluoran, 3-N-methyl-N-isobutyl-6-methyl-7-anilinofluoran, 3-morpholino-7-(N-propyl-trifluoromethylanilino) fluoran,

3-pyrrolidino-7-m-trifluoromethylanilinofluoran, 3-diethylamino-5-chloro-7-(N-benzyl-trifluoromethylanilino) fluoran, 3-pyrrolidino-7-(di-p-chlorophenyl) methylaminofluoran, 3-diethylamino-5-chloro-7-(α-phenylethylamino) fluoran, 3-(N-ethyl-p-toluidino)-7-(α-phenylethylamino) fluoran, 3-diethylamino-7-(o-methoxycarbonylphenylamino) fluoran, 3-diethylamino-5-methyl-7-(α-phenylethylamino) fluoran, 3-diethylamino-7-piperidinofluoran, 2-chloro-3-(N-methyltoluidino)-7-(p-n-butylanilino) fluoran, 3-(N-methyl-N-isopropylamino)-6-methyl-7-anilinofluoran, 3-di-n-butylamino-6-methyl-7-anilinofluoran, 3,6-bis(dimethylamino) fluorene spiro (9,3′)-6′-dimethylaminophthalide, 3-(N-benzyl-N-cyclohexylamino)-5,6-benzo-7-α-naphthylamino-4′-bromofluoran, 3-diethylamino-6-chloro-7-anilinofluoran, 3-diethylamino-6-methyl-7-mesityzino-4′,5′-benzofluoran, 3-N-methyl-N-isopropyl-6-methyl-7-anilinofluoran, 3-N-ethyl-N-isoamyl-6-methyl-7-anilinofluoran, 3-Diethylamino-6-methyl-7-(2′, 4′-dimethylanilino) fluoran, and the like.

The water-dispersible sheet of the present invention are possibly used in an application to be washed away to a drainage groove after use, therefore, among these, preferably used are leuco dyes with higher safety from the viewpoint of environment, such as 3-diethylamino-6-methyl-7-anilinofluoran, 3-dibutylamino-6-methyl-7-anilinofluoran, 3-(N-cyclohexyl-N-methylamino)-6-methyl-7-anilinofluoran, 3-(N-ethyl-N-isopentylamino)-6-methyl-7-anilinofluoran, 3-N-di-n-pentylamino-6-methyl-7-anilinofluoran, 3-diethylamino-7-(3-trifluoromethylanilino) fluoran, 3-(N-ethyl-N-4-methylphenylamino)-6-methyl-7-anilinofluoran, 3-diethylamino-6-methyl-7-(3-methylanilino) fluoran, 3,3′-bis (dimethylaminophenyl)-6-dimethylaminophthalide, 3-(4-diethylamino-2-ethoxyphenyl)-3-(1-ethyl-2-methylindol-3-yl)-4-azaphthalide, 2-(N-phenyl-N-methylamino)-6-(N-p-tolyl-N-ethylamino) fluoran, 3,3-bis(1-n-butyl-2-methyl-indol-3-yl) phthalide, 1,3-dimethyl-6-diethylaminofluoran, 3-Bromo-3-methyl-6-dibutylaminofluoran, and the like.

As the color developing agent contained in the thermosensitive recording layer together with the leuco dye, phenols, organic acids or inorganic acids or their esters, salts and the like may be used. Example of the color developing agent include gallic acid, salicylic acid, 3-isopropylsalicylic acid, 3-cyclohexylsalicylic acid, 3,5-di-tert-butylsalicylic acid, 3,5-di-α-methylbenzylsalicylic acid, 4,4′-isopropylidenediphenol, 1,1′-isopropylidenebis(2-chlorophenol), 4,4′-isopropylin bis(2,6-dibromophenol), 4,4′-isopropylidenebis(2,6-dichlorophenol), 4,4′-isopropylidenebis(2-methylphenol), 4,4′-isopropylidenebis(2,6-dimethylphenol), 4,4-isopropylidenebis(2-tert-butylphenol), 4,4′-sec-butylidenediphenol, 4,4′-cyclohexylidene bisphenol, 4,4′-cyclohexylidene bis(2-methylphenol), 4-tert-butylphenol, 4-phenylphenol, 4-hydroxydiphenoxide, α-naphthol, 6-naphthol, 3,5-xylenol, thymol, methyl-4-hydroxybenzoate, 4-hydroxyacetophenone, novolac type phenolic resin, 2,2′-thiobis(4,6-dichlorophenol), catechol, resorcin, hydroquinone, pyrogallol, fluoroglycine, fluoroglycine carboxylic acid, 4-tert-octyl catechol, 2,2′-methylenebis(4-chlorophenol), 2,2′-methylenebis(4-methyl-6-tert-butylphenol), 2,2′-dihydroxydiphenyl, ethyl p-hydroxybenzoate, propyl p-hydroxybenzoate, butyl p-hydroxybenzoate, benzyl p-hydroxybenzoate, p-hydroxybenzoic acid-p-chlorobenzyl, p-hydroxybenzoic acid-o-chlorobenzyl, p-hydroxybenzoic acid-p-methylbenzyl, p-hydroxybenzoic acid-n-octyl, benzoic acid, zinc salicylate, 1-hydroxy-2-naphthoic acid, 2-hydroxy-6-naphthoic acid, zinc 2-hydroxy-6-naphthoate, 4-hydroxydiphenyl sulfone, 4-hydroxy-4′-chlorodiphenyl sulfone, bis(4-hydroxyphenyl) sulfide,

2-hydroxy-p-toluic acid, zinc 3,5-di-tert-butylsalicylate, 3,5-di-tert-butyl salicylate, tartaric acid, oxalic acid, maleic acid, citric acid, succinic acid, stearic acid, 4-hydroxyphthalic acid, boric acid, thiourea derivatives, 4-hydroxythiophenol derivatives, bis(4-hydroxyphenyl) acetic acid, ethyl bis(4-hydroxyphenyl) acetate, N-propyl bis(4-hydroxyphenyl) acetate, N-butyl bis(4-hydroxyphenyl) acetate, phenyl bis(4-hydroxyphenyl) acetate, bis(4-hydroxyphenyl) acetate benzyl, phenethyl bis(4-hydroxyphenyl) acetate, bis(3-methyl-4-hydroxyphenyl) acetic acid, methyl bis(3-methyl-4-hydroxyphenyl) acetate, N-propyl bis(3-methyl-4-hydroxyphenyl) acetate, 1,7-bis(4-hydroxyphenylthio) 3,5-dioxaheptane, 1,5-bis(4-hydroxyphenylthio) 3-oxapentane, dimethyl 4-hydroxyphthalate, 4-hydroxy- 4′-methoxydiphenyl sulfone, 4-hydroxy-4′-ethoxydiphenyl sulfone, 4-hydroxy-4′-isopropoxy diphenyl sulfone, 4-hydroxy-4′-propoxy diphenyl sulfone, 4-hydroxy-4′-butoxydiphenyl sulfone, 4-hydroxy-4′-isobutoxydiphenyl sulfone, 4-hydroxy-4′-sec-butoxydiphenyl sulfone, 4-hydroxy-4′-tert-butoxydiphenyl sulfone, 4-hydroxy-4′-benzyloxy diphenyl sulfone, 4-hydroxy-4′-phenoxydiphenyl sulfone, 4-hydroxy-4′-(m-methylbenzyloxy) diphenyl sulfone, 4-hydroxy-4′-(p-methylbenzyloxy) diphenyl sulfone, 4-hydroxy-4′-(o-methylbenzyloxy) diphenyl sulfone, 4-hydroxy-4′-(p-chlorobenzyloxy) diphenylsulfone and the like.

The water-dispersible sheet of the present invention are possibly used in an application to be washed away to a drainage groove after use, therefore, among these, preferably used are color developing agents with higher safety from the viewpoint of environment, such as 4,4′-dihydroxydiphenyl sulfone, 2,4′-dihydroxydiphenyl sulfone, 4-hydroxy-4′-isopropoxy diphenyl sulfone, benzyl parahydroxybenzoate, 4-hydroxy-4′-propoxy diphenyl sulfone, 3-{[(phenylamino) carbonyl] amino} benzenesulfonamide, N-(4′-hydroxyphenylthio) acetyl-2-hydroxyaniline, 1:1 mixture of N-(4′-hydroxyphenylthio) acetyl-4-hydroxyaniline and N-(4′-hydroxyphenylthio) acetyl-2-hydroxyaniline, 4,4′-bis(3-(phenoxycarbonylamino) methylphenylureido) diphenyl sulfone, composition of color developing agents containing 2,2′-bis [4-(4-hydroxyphenylsulfone) phenoxy] diphenyl ether, and the like.

Any known binders can be used for the thermosensitive recording layer. Examples of the main ingredient of the binder include polyvinyl alcohols such as fully saponified polyvinyl alcohol and partially saponified polyvinyl alcohol; modified polyvinyl alcohols such as carboxy-modified polyvinyl alcohol, amide-modified polyvinyl alcohol, sulfonic acid-modified polyvinyl alcohol, butyral-modified polyvinyl alcohol, and other modified polyvinyl alcohol; water-soluble resin such as hydroxyethyl cellulose, methyl cellulose, carboxymethyl cellulose salt, starches, gelatin, casein, sodium alginate, polyvinyl pyrrolidone, polyacrylamide, acrylamide/acrylate copolymer, alkali salt of styrene/maleic anhydride copolymer, alkali salt of ethylene/maleic anhydride copolymer; water dispersible resins such as styrene-butadiene copolymer, acrylonitrile/butadiene copolymer, methyl acrylate/butadiene copolymer, acrylonitrile/butadiene/styrene terpolymer, cellulose derivatives such as ethyl cellulose, acetyl cellulose, polyvinyl chloride, polyvinyl acetate, vinyl acetate/acrylic acid ester copolymer, ethylene/vinyl acetate copolymer, polyacrylic esters, styrene/acrylate copolymer, polyurethane resin, polyvinyl butyral polystyrene and copolymers thereof, polyamide resin, silicone resin, petroleum resin, terpene resin, ketone resin, coumarone resin. These may be used by being dissolved into a solvent such as water, alcohol, ketone, ester, hydrocarbon, etc. These also may be used in a state of being emulsified or paste dispersed in water or other medium, and these may also be used in combination depending on the required quality. Among these, water-soluble resins are preferably used as the main ingredient of the binder from the viewpoint of water dispersibility, such as starches, hydroxyethyl cellulose, methyl cellulose, carboxymethyl cellulose salt, gelatin, casein, sodium alginate, polyvinyl alcohols, modified polyvinyl alcohols, and polyvinylpyrrolidone.

In the thermosensitive recording layer, auxiliary additives may be used together with the leuco dye, the color developing agent and the binder, if necessary. Examples of the auxiliary additives include sensitizers, pigments, stabilizers such as p-nitrobenzoic acid metal salt (Ca, Zn) or phthalic acid monobenzyl ester metal salt (Ca, Zn), releasing agents such as fatty acid metal salt, lubricants such as waxes, pressure coloring preventing agents, benzophenone and triazole UV absorbers, waterproofing agents such as glyoxal, dispersing agents, antifoaming agents, etc.

Thermoplastic materials are used as a sensitizer to improve the thermal responsiveness, and a thermoplastic organic compound with a melting point of about 50 to 200 degree C. may be used. Examples of such thermoplastic organic compound include stearic acid amide, palmitic acid amide, N-hydroxymethylstearic acid amide, N-stearyl stearic acid amide, ethylene bis stearic acid amide, N-stearyl urea, benzyl-2-naphthyl ether, m-terphenyl, 4-benzylbiphenyl, 2,2′-bis(4-methoxyphenoxy) diethyl ether, α, α′-diphenoxyxylene, bis(4-methoxyphenyl) ether, diphenyl adipate, dibenzyl oxalate, di (4-chlorobenzyl) oxalate, dimethyl terephthalate, dibenzyl terephthalate, benzenesulfonic acid phenyl ester, bis(4-allyloxyphenyl) sulfone, 4-acetylacetophenone, acetoacetic acid anilides, fatty acid anilides, montan wax, polyethylene wax, benzyl p-benzyloxybenzoate, di-p-tolyl carbonate, phenyl-α-naphthyl carbonate, 1,4-diethoxynaphthalene, 1-hydroxy-2-naphthoic acid phenyl ester, 1,2-bis-(3-methylphenoxy) ethane, di (p-methylbenzyl) oxalate, 1,2-bis (phenoxymethyl) benzene, diphenyl sulfone, para phenyl acetophenone, ß-benzyloxynaphthalene, 4-biphenyl-p-tolyl ether, o-xylerine-bis-(phenyl ether), 4-(m-methylphenoxymethyl) biphenyl and the like.

The water-dispersible sheet of the present invention are possibly used in an application to be washed away to a drainage groove after use, therefore, among these, preferably used are sensitizers with higher safety from the viewpoint of environment, such as stearic acid amide, palmitic acid amide, ethylene bis stearic acid amide, benzyl p-benzyloxybenzoate, 4-biphenyl-p-tolyl ether, di (p-methylbenzyl) oxalate, di (4-chlorobenzyl) oxalate, 4-benzylbiphenyl, 1,2-bis (phenoxymethyl) benzene, diphenyl sulfone, ß-benzyloxynaphthalene, paraphenylacetophenone, 1,2-bis-(3-methylphenoxy) ethane, and the like.

Examples of the pigments include inorganic filler, such as silica, calcium carbonate, clay, kaolin, calcined kaolin, diatomaceous earth, talc, titanium oxide, aluminum hydroxide, magnesium carbonate, zinc oxide, aluminum oxide, magnesium hydroxide, barium sulfate, calcium sulfate, zinc sulfate, calcium silicate, aluminum silicate, magnesium silicate, sodium aluminosilicate, magnesium aluminosilicate and the like; or organic pigments, such as melamine resin pigment, urea-formalin resin pigment, polyethylene powder, nylon powder and the like.

The types and amounts of the leuco dye, color developing agent, sensitizer and other various ingredients are determined according to the required performance and printability and are not particularly restricted. However, from 0.5 parts to 10 parts of the color developing agent and from 0.5 parts to 10 parts of the sensitizer are ordinarily used per 1 part of the leuco dye, and the amount of the binder is suitably 5 to 50% by weight in the total solid content.

The leuco dye, the color developing agent and the materials added when needed are finely ground into particles, several microns or smaller in size, using a grinder or a suitable emulsification device such as a ball mill, attritor, sand grinder and the like, and a coating solution is prepared by adding a binder and various additive materials depending on the objective.

The method for forming the thermosensitive recording layer is not limited in particular, and the layer is formed by, for example, coating and drying the coating material on the base paper by a method such as various printing methods such as planographic printing, or air knife coating, rod blade coating, bar coating, blade coating, gravure coating, curtain coating and the like. The coating amount of the thermosensitive recording layer is usually in the range of from 2 to 12 g/m², preferably from 3 to 10 g/m².

Also, the matching property with the thermal head or the like and the storage image storage property can be improved by optionally installing a protective layer on the thermosensitive recording layer.

As the binder used for the protective layer, the same type as the binder used for thermosensitive recording layer may be used. Examples of the main ingredient of the binder include polyvinyl alcohols such as fully saponified polyvinyl alcohol and partially saponified polyvinyl alcohol; modified polyvinyl alcohols such as carboxy-modified polyvinyl alcohol, amide-modified polyvinyl alcohol, sulfonic acid-modified polyvinyl alcohol, butyral-modified polyvinyl alcohol, and other modified polyvinyl alcohol; water-soluble resin such as hydroxyethyl cellulose, methyl cellulose, carboxymethyl cellulose salt, starches, gelatin, casein, sodium alginate, polyvinyl pyrrolidone, polyacrylamide, acrylamide/acrylate copolymer, alkali salt of styrene/maleic anhydride copolymer, alkali salt of ethylene/maleic anhydride copolymer; water dispersible resins such as styrene-butadiene copolymer, acrylonitrile/butadiene copolymer, methyl acrylate/butadiene copolymer, acrylonitrile/butadiene/styrene terpolymer, cellulose derivatives such as ethyl cellulose, acetyl cellulose, polyvinyl chloride, polyvinyl acetate, vinyl acetate/acrylic acid ester copolymer, ethylene/vinyl acetate copolymer, polyacrylic esters, styrene/acrylate copolymer, polyurethane resin, polyvinyl butyral polystyrene and copolymers thereof, polyamide resin, silicone resin, petroleum resin, terpene resin, ketone resin, coumarone resin. These may be used by being dissolved into a solvent such as water, alcohol, ketone, ester, hydrocarbon, etc. These also may be used in a state of being emulsified or paste dispersed in water or other medium, and these may also be used in combination depending on the required quality. Among these, water-soluble resins are preferably used as the main ingredient of the binder from the viewpoint of water dispersibility, such as starches, hydroxyethyl cellulose, methyl cellulose, carboxymethyl cellulose salt, gelatin, casein, sodium alginate, polyvinyl alcohols, modified polyvinyl alcohols, and polyvinylpyrrolidone.

Examples of the additives used for the protective layer include pigments, surfactants, lubricants, pressure coloring inhibitors, and the like. The specific examples of the pigment and the lubricant are the same as those exemplified in the thermosensitive recording layer. The protective layer is obtained by preparing the coating material by dispersing and mixing various additives in the binder, applying the coating material in one or more layers by a coating machine and drying it by heating with a dryer.

The coating amount (solid content) of the protective layer is usually 0.2 to 10 g/m², preferably 0.5 to 5 g/m². The coating machine is not particularly limited, and known coating machines can be used such as air knife coater, bar coater, roll coater, blade coater, curtain coater, champlex coater, gravure coater and the like.

In the present invention, it is preferable to increase the surface smoothness of the thermosensitive recording layer side of the water-dispersible sheet in order to improve the image sharpness and sensitivity by using a smoothing device such as calendar, super calendar, soft nip calender or the like.

The Bekk smoothness on the surface of the thermosensitive recording layer side is preferably 50 to 2000 seconds, more preferably 100 to 2000 seconds. If the Bekk smoothness is less than 50 seconds, the effect of improving the image sharpness and sensitivity may be poor. Also, if the Bekk smoothness exceeds 2000 seconds, a decrease in water dispersibility may become apparent due to the increase in the density of the base paper, which is not preferable.

(II) Example of Coating Layer Suitable for Inkjet Printers (Inkjet Recording Layer):

In order to adapt the water-dispersible sheet of the present invention to printing with an inkjet printer, it is preferable to install, on the other side of the water-dispersible sheet, opposite to the tacky adhesive layer, a pigment coating layer comprising a pigment and an aqueous binder as main components or a clear coat layer comprising a cationic resin and/or an aqueous binder as main components. The pigment, binder and various additives may be selected appropriately from any known pigments, binders and various additives and used, and the compounding amounts of these may be appropriately adjusted according to the required quality. In addition, since the base paper contains a porous layer (having high ink absorbability) comprising fibrous carboxyalkyl cellulose, it has an improved ink absorbability.

Examples of the pigments include inorganic pigments such as silica, colloidal silica, calcium carbonate, clay, kaolin, calcined kaolin, diatomaceous earth, talc, titanium oxide, aluminum hydroxide, magnesium carbonate, zinc oxide, aluminum oxide, magnesium hydroxide, barium sulfate, calcium sulfate, zinc sulfate, calcium silicate, aluminum silicate, magnesium silicate, sodium aluminosilicate, magnesium aluminosilicate, calcium carbonate complex silica; or organic pigments such as melamine resin pigment, urea-formalin resin pigment, polyethylene powder, nylon powder, styrene, styrene-acryl, acryl. Among these, silica, alumina, calcined kaolin, calcium carbonate or the like are preferably used from the viewpoints of ink absorbability and coloring property.

As the binder, water-soluble resins and water-dispersible resins are preferred, such as starch, hydroxyethyl cellulose, methyl cellulose, carboxymethyl cellulose salt, gelatin, casein, sodium alginate, polyvinyl alcohol, modified polyvinyl alcohol, polyvinyl pyrrolidone, polyacrylamide, acrylamide/acrylate copolymer, styrene/maleic anhydride copolymer and its alkali salt, ethylene/maleic anhydride copolymer and its alkali salt, styrene/butadiene copolymer, sodium polyacrylate, vinyl acetate, ethylene-vinyl acetate, acrylic acid copolymer, methacrylic acid copolymer, acrylic acid/methacrylic acid copolymer and the like. Among these, polyvinyl alcohol, modified polyvinyl alcohol, or the like are preferably used from the viewpoints of ink absorbability and coloring property.

Examples of the additives include cationic resins (dye fixing agents), pigment dispersants, defoaming agents, lubricants, UV absorbers, sizing agents, fluorescent dyes, preservatives, and the like. Among these, cationic resin is preferably used in combination because it significantly improves the water resistance and color development of the image area.

The coating machine is not particularly limited, and air knife coater, bar coater, roll coater, blade coater, curtain coater, cast coater, champlex coater, gravure coater, two rolls coater, transfer roll coater, and the like may be used.

(III) Example of Coating Layer Suitable for Gravure Printing:

In order to adapt the water-dispersible sheet of the present invention to gravure printing, it is preferable to install, on the other side of the water-dispersible sheet, opposite to the tacky adhesive layer, a pigment coating layer comprising a pigment and an aqueous binder as main components or a clear coat layer comprising an aqueous binder as main components. The pigment, binder and various additives may be selected appropriately from any known pigments, binders and various additives and used. In addition, since the base paper contains a porous layer (having high cushioning property) comprising fibrous carboxyalkyl cellulose, it has an improved ink adherence.

Examples of the pigments include inorganic pigment such as calcium carbonate, clay, kaolin, calcined kaolin, diatomaceous earth, talc, titanium oxide, aluminum hydroxide, magnesium carbonate, zinc oxide, aluminum oxide, magnesium hydroxide, barium sulfate, calcium sulfate, zinc sulfate, calcium silicate, aluminum silicate, magnesium silicate, sodium aluminosilicate, magnesium aluminosilicate, silica, colloidal silica, calcium carbonate composite silica and the like; or organic pigment such as melamine resin pigment, urea-formalin resin pigment, polyethylene powder, nylon powder, styrene, styrene-acryl, acryl and the like.

As the binder, water-soluble resins and water-dispersible resins are preferred, such as starch, hydroxyethyl cellulose, methyl cellulose, carboxymethyl cellulose salt, gelatin, casein, sodium alginate, polyvinyl alcohol, modified polyvinyl alcohol, polyvinyl pyrrolidone, polyacrylamide, acrylamide/acrylate copolymer, styrene/maleic anhydride copolymer and its alkali salt, ethylene/maleic anhydride copolymer and its alkali salt, styrene/butadiene copolymer, sodium polyacrylate, vinyl acetate, ethylene-vinyl acetate, acrylic acid copolymer, methacrylic acid copolymer, acrylic acid/methacrylic acid copolymer and the like. Among these, from the viewpoint of water dispersibility, preferred binders are water-soluble resins such as starch, hydroxyethyl cellulose, methyl cellulose, carboxymethyl cellulose salt, gelatin, casein, sodium alginate, polyvinyl alcohol, modified polyvinyl alcohol, polyvinyl pyrrolidone.

Examples of the additives include cationic resins (dye fixing agents), pigment dispersants, defoaming agents, lubricants, UV absorbers, sizing agents, fluorescent dyes, preservatives, and the like.

The coating machine is not particularly limited, and air knife coater, bar coater, roll coater, blade coater, curtain coater, cast coater, champlex coater, gravure coater, two rolls coater, transfer roll coater, and the like may be used.

The water-dispersible sheet of the present invention thus obtained can, after it is adhered to a substrate such as a container or a returnable container, be easily removed from the substrate only by being rinsed off with water.

### EXAMPLES

The following Examples illustrate the present invention, but the Examples are not intended to limit the scope of the present invention.

### Example 1

A hand-made paper of a single layer sheet (basic weight: 54 g/m²) (hereinafter also referred to as “pulp sheet”) was prepared using a papermaking material, which comprises 80% by weight of hardwood bleached kraft pulp beaten to 550 ml CSF of Canadian standard freeness as a papermaking pulp and 20% by weight of a fibrous carboxymethyl cellulose (hereinafter referred to as “fibrous CMC”, Degree of etherification (DS) is 0.43). Then a water-dispersible sheet was prepared by applying an aqueous solution of sodium carbonate (soda ash light manufactured by Tokuyama Corporation) as an alkalizing agent and carboxymethyl cellulose sodium salt powder (hereinafter referred to as “CMC-Na salt”, trade name: Sunrose, manufactured by Nippon Paper Industries Co., Ltd., Degree of etherification (DS) of 0.7, viscosity of 3 mPa-s as 1% by weight aqueous solution at 20 degree C.) on the hand-made paper by a size press method, so that the amount of the sodium carbonate with respect to the hand-made paper is 8.0 wt % (the amount of the sodium carbonate on the hand-made paper is 4.3 g/m²) and the amount of the carboxymethyl cellulose sodium salt with respect to the hand-made paper is 3.1 wt % (the amount of the carboxymethyl cellulose sodium salt on the hand-made paper is 1.7 g/m²).

### Example 2

A water-dispersible sheet was prepared in the same manner as in Example 1 with the exception of beating the hardwood bleached kraft pulp up to Canadian standard freeness of 650 mL CSF.

### Example 3

A water-dispersible sheet was prepared in the same manner as in Example 1 with the exception of beating the hardwood bleached kraft pulp up to Canadian standard freeness of 450 mL CSF.

### Example 4

A water-dispersible sheet was prepared in the same manner as in Example 1 with the exception of applying an aqueous solution of the sodium carbonate and carboxymethyl cellulose sodium salt (trade name: Sunrose, manufactured by Nippon Paper Industries Co., Ltd., Degree of etherification (DS) of 0.9, viscosity of 28 mPa-s as 1% by weight aqueous solution at 20 degree C.) on the hand-made paper by a size press method, so that the amount of the sodium carbonate with respect to the hand-made paper is 8.0 wt % and the amount of the carboxymethyl cellulose sodium salt with respect to the hand-made paper is 3.1 wt %.

### Example 5

A water-dispersible sheet was prepared in the same manner as in Example 1 with the exception of applying an aqueous solution of the sodium carbonate and carboxymethyl cellulose sodium salt (trade name: Sunrose, manufactured by Nippon Paper Industries Co., Ltd., Degree of etherification (DS) of 0.7, viscosity of 170 mPa-s as 1% by weight aqueous solution at 20 degree C.) on the hand-made paper by a size press method, so that the amount of the sodium carbonate with respect to the hand-made paper is 8.0 wt % and the amount of the carboxymethyl cellulose sodium salt with respect to the hand-made paper is 3.1 wt %.

### Example 6

A water-dispersible sheet was prepared in the same manner as in Example 1 with the exception of applying an aqueous solution of the sodium carbonate and the carboxymethyl cellulose sodium salt on the hand-made paper by a size press method, so that the amount of the sodium carbonate with respect to the hand-made paper is 9.3 wt % (the amount of the sodium carbonate on the hand-made paper is 5.0 g/m²) and the amount of the carboxymethyl cellulose sodium salt with respect to the hand-made paper is 1.9 wt % (the amount of the carboxymethyl cellulose sodium salt on the hand-made paper is 1.0 g/m²).

### Example 7

A water-dispersible sheet was prepared in the same manner as in Example 1 with the exception of preparing a hand-made paper of a single layer sheet (basic weight: 54 g/m²) by using a papermaking material, which comprises 50% by weight of the hardwood bleached kraft pulp and 50% by weight of the fibrous carboxymethyl cellulose (Degree of etherification (DS) is 0.43).

### Example 8

A hand-made paper of a single layer sheet (basic weight: 54 g/m²) was prepared using a papermaking material, which comprises 70% by weight of hardwood bleached kraft pulp beaten to 250 ml CSF of Canadian standard freeness and 30% by weight of a fibrous carboxymethyl cellulose (Degree of etherification (DS) is 0.43). Then a water-dispersible sheet was prepared in the same manner as in Example 1 with the exception of applying an aqueous solution of the sodium carbonate and the carboxymethyl cellulose sodium salt on the hand-made paper by a size press method, so that the amount of the sodium carbonate with respect to the hand-made paper is 10.5 wt % (the amount of the sodium carbonate on the hand-made paper is 5.5 g/m²) and the amount of the carboxymethyl cellulose sodium salt with respect to the hand-made paper is 4.2 wt % (the amount of the carboxymethyl cellulose sodium salt on the hand-made paper is 2.2 g/m²).

### Example 9

A water-dispersible sheet was prepared in the same manner as in Example 1 with the exception of preparing a hand-made paper of a single layer sheet (basic weight: 54 g/m²) by using a papermaking material, which comprises 95% by weight of hardwood bleached kraft pulp beaten to 650 ml CSF of Canadian standard freeness and 5% by weight of a fibrous carboxymethyl cellulose (Degree of etherification (DS) is 0.43).

### Example 10

A tacky adhesive coating solution with the following formulation was prepared. Then this tacky adhesive was applied on a release treatment surface of a commercially available release sheet coated with a silicone release agent with a solid weight of 25 g/m² and dried to prepare a release sheet on which an adhesive layer was formed.

### <Tacky Adhesive Coating Solution>

| | |
|---|---|
| Water-soluble acrylic adhesive (VIGteQnos Co., | 100 parts |
| Ltd., trade name “Riki-Dyne AR-2410”, | |
| solid content 42 wt %) | |
| Crosslinking agent (VIGteQnos Co., Ltd., | 0.1 parts |
| trade name “Sunpasta HD-5013”) | |

This tacky adhesive layer on the release sheet was then adhered to the water-dispersible sheet prepared in Example 1 to prepare a water-dispersible sheet.

### Example 11

The color development agent dispersion (solution A), the leuco dye dispersion (solution B) and the sensitizer dispersion (solution C) with the following formulations were separately wet ground using sand grinders until the average particle size was about 1.0 μm.

### Color Development Agent Dispersion (Solution A)

| | |
|---|---|
| 4-Hydroxy-4′-isopropoxy diphenyl sulfone | 6.0 parts |
| (Nippon Soda Co., Ltd., D8) | |
| Aqueous solution of completely saponified | 18.8 parts |
| polyvinyl alcohol (Kuraray Co., Ltd. | |
| PVA117, solid content: 10%) | |
| Water | 11.2 parts |

### Leuco Dye Dispersion (Solution B)

| | |
|---|---|
| 3-Dibutylamino-6-methyl-7-anilinofluorane | 2.0 parts |
| (Yamamoto Chemicals Inc. ODB-2) | |
| Aqueous solution of completely saponified | 4.6 parts |
| polyvinyl alcohol (Kuraray Co., Ltd. | |
| PVA117, solid content: 10%) | |
| Water | 2.6 parts |

### Sensitizer Dispersion (Solution C)

| | |
|---|---|
| 4-biphenyl-p-tolyl ether | 4.0 parts |
| (Nicca Chemical Co., Ltd.) | |
| Aqueous solution of completely saponified | 5.0 parts |
| polyvinyl alcohol (Kuraray Co., Ltd. | |
| PVA117) | |
| Water | 3.0 parts |

Then, these dispersions were blended in the proportion described below to prepare the thermosensitive recording layer coating solution.

### Thermosensitive Recording Layer Coating Solution

| | |
|---|---|
| Color development agent dispersion (Solution A) | 36.0 parts |
| Leuco dye dispersion (Solution B) | 9.2 parts |
| Sensitizer dispersion (Solution C) | 12.0 parts |

This thermosensitive recording layer coating solution was applied on one surface of the water-dispersible sheet prepared in Example 1 with a coating weight (in solid) of 6.0 g/m² and was dried (at 50 degree C.) to form a thermosensitive recording layer, then the sheet was subjected to a smoothing treatment so that its Bekk smoothness was 500 to 1000 seconds to obtain a water-dispersible sheet.

### Example 121

The thermosensitive recording layer coating solution prepared in the same manner as in Example 11 was applied on one surface of the water-dispersible sheet prepared in Example 1. Then the tacky adhesive layer of the release sheet prepared in the same manner as in Example 10 was adhered to the other surface of this water-dispersible sheet to prepare a water-dispersible sheet.

### Comparative Example 11

A water-dispersible sheet was prepared in the same manner as in Example 1 with the exception of removing CMC-Na salt from the aqueous solution being applied on the hand-made paper by a size press method.

### Comparative Example 21

A water-dispersible sheet was prepared in the same manner as in Example 1 with the exception of removing sodium carbonate (i.e. alkalizing agent) from the aqueous solution being applied on the hand-made paper by a size press method.

### Comparative Example 31

A water-dispersible sheet was prepared in the same manner as in Example 1 with the exception of preparing the hand-made paper without using the fibrous CMC.

### Comparative Example 41

A water-dispersible sheet was prepared in the same manner as in Example 1 with the exception of using a carboxymethyl cellulose sodium salt powder (trade name: Sunrose, manufactured by Nippon Paper Industries Co., Ltd., Degree of etherification (DS) of 0.25, viscosity of 75 mPa-s as 1% by weight aqueous solution at 20 degree C.) as the CMC-Na salt.

### Comparative Example 5

A water-dispersible sheet was prepared in the same manner as in Example 1 with the exception of using a carboxymethyl cellulose sodium salt powder (trade name: Sunrose, manufactured by Nippon Paper Industries Co., Ltd., Degree of etherification (DS) of 0.7, viscosity of 550 mPa-s as 1% by weight aqueous solution at 20 degree C.) as the CMC-Na salt.

### Comparative Example 6

A water-dispersible sheet was prepared in the same manner as in Example 1 with the exception of the amount of the CMC-Na salt with respect to the hand-made paper being 18.0 wt %.

### Comparative Example 7

A water-dispersible sheet was prepared in the same manner as in Example 12 with the exception of removing CMC-Na salt from the aqueous solution being applied on the hand-made paper by a size press method.

The following evaluations were conducted on thus prepared water-dispersible sheets. When evaluating the water dispersibility, the release paper was removed before the evaluation.

### 1) Water Dispersibility

Five test pieces of 3 cm square were prepared from the sample which had been conditioned in an atmosphere of 23 degree C. and 50% RH for 24 hours or more. Then, one piece of the above test piece was put into a 300 ml beaker with 300 ml of deionized water while stirring at 650 rpm with a stirrer. The time when the test piece was completely loosened into individual fibers and became fibrous was measured with a stopwatch. Then the average value of five measurements was taken as the water dispersion time. The shorter the water dispersion time, the better the water dispersibility.

### 2) Tensile Test

The tensile strength was measured according to Japanese Industrial Standards (JIS) P8113 on the water-dispersible sheet samples which had been conditioned in an atmosphere of 23 degree C. and 50% RH for 24 hours or more.

### 3) Air Permeability

The volume of air passing through 1 cm² surface of the sample per minute with 100 mm H₂O of the differential pressure was measured by using the air permeability manual measuring instrument (model PPM100 type, manufactured by Filtroner).

Table 1 shows the structure and the evaluation results of the prepared water-dispersible sheets.

TABLE 1

| | Pulp sheet | | | | Coating | | | |
|---|---|---|---|---|---|---|---|---|
| | Papermaking | | Fibrous | | Alkalizing agent | CMC-Na salt | | |
| | pulp | | CMC | | Amount against | | 1% Visicisity | Amount per |
| | Freeness | Amount | | Amount | pulp sheet | | at 20 degree | pulp sheet |
| | (mlCSF) | (%) | DS | (%) | (solid %) | DS | C. (mPa · s) | (solid %) |
| Example 1 | 550 | 80 | 0.43 | 20 | 8.0 | 0.7 | 3 | 3.1 |
| Example 2 | 650 | 80 | 0.43 | 20 | 8.0 | 0.7 | 3 | 3.1 |
| Example 3 | 450 | 80 | 0.43 | 20 | 8.0 | 0.7 | 3 | 3.1 |
| Example 4 | 550 | 80 | 0.43 | 20 | 8.0 | 0.9 | 28 | 3.1 |
| Example 5 | 550 | 80 | 0.43 | 20 | 8.0 | 0.7 | 170 | 3.1 |
| Example 6 | 550 | 80 | 0.43 | 20 | 9.3 | 0.7 | 3 | 1.9 |
| Example 7 | 550 | 50 | 0.43 | 50 | 8.0 | 0.7 | 3 | 3.1 |
| Example 8 | 250 | 30 | 0.43 | 70 | 10.5 | 0.7 | 3 | 4.2 |
| Example 9 | 650 | 95 | 0.43 | 5 | 8.0 | 0.7 | 3 | 3.1 |
| Example 10 | 550 | 80 | 0.43 | 20 | 8.0 | 0.7 | 3 | 3.1 |
| Example 11 | 550 | 80 | 0.43 | 20 | 8.0 | 0.7 | 3 | 3.1 |
| Example 12 | 550 | 80 | 0.43 | 20 | 8.0 | 0.7 | 3 | 3.1 |
| Comparative | 550 | 80 | 0.43 | 20 | 8.0 | — | — | 0.0 |
| Example 1 | | | | | | | | |
| Comparative | 550 | 80 | 0.43 | 20 | 0 | 0.7 | 3 | 3.1 |
| Example 2 | | | | | | | | |
| Comparative | 550 | 100 | — | 0 | 8.0 | 0.7 | 3 | 3.1 |
| Example 3 | | | | | | | | |
| Comparative | 550 | 80 | 0.43 | 20 | 8.0 | 0.25 | 75 | 3.1 |
| Example 4 | | | | | | | | |
| Comparative | 550 | 80 | 0.43 | 20 | 8.0 | 0.7 | 550 | 3.1 |
| Example 5 | | | | | | | | |
| Comparative | 550 | 80 | 0.43 | 20 | 8.0 | 0.7 | 3 | 18.0 |
| Example 6 | | | | | | | | |
| Comparative | 550 | 80 | 0.43 | 20 | 8.0 | — | — | 0.0 |
| Example 7 | | | | | | | | |

| | | | Evaluation result | | |
|---|---|---|---|---|---|
| | Tacky | Thermosensitive | Water | Tensile | Air |
| | adhesive | recording | dispersion | strength | permeability |
| | layer | layer | time (sec) | (kN/m) | (CORESTA) |
| Example 1 | — | — | 35 | 3.4 | 642 |
| Example 2 | — | — | 19 | 2.8 | — |
| Example 3 | — | — | 49 | 3.7 | — |
| Example 4 | — | — | 42 | 3.8 | — |
| Example 5 | — | — | 52 | 4.4 | — |
| Example 6 | — | — | 41 | 3.3 | — |
| Example 7 | — | — | 17 | 3.5 | — |
| Example 8 | — | — | 51 | 2.5 | — |
| Example 9 | — | — | 34 | 3.0 | — |
| Example 10 | installed | — | 36 | 3.3 | — |
| Example 11 | — | installed | 108 | 6.6 | — |
| Example 12 | installed | installed | 114 | 6.5 | — |
| Comparative | — | — | 60 | 2.4 | — |
| Example 1 | | | | | |
| Comparative | — | — | longer | 3.1 | — |
| Example 2 | | | than 300 | | |
| Comparative | — | — | longer | 3.7 | — |
| Example 3 | | | than 300 | | |
| Comparative | — | — | 64 | 3.5 | — |
| Example 4 | | | | | |
| Comparative | — | — | longer | 4.3 | 139 |
| Example 5 | | | than 300 | | |
| Comparative | — | — | 75 | 5.9 | — |
| Example 6 | | | | | |
| Comparative | installed | installed | 195 | 4.7 | — |
| Example 7 | | | | | |

It is derived from Table 1 that a water-dispersible sheet with further improved water dispersibility can be obtained by using two kinds of compounds, a specific alkalized fibrous carboxyalkyl cellulose and a specific carboxyalkyl cellulose sodium salt.

On the other hand, when using a carboxymethyl cellulose sodium salt with high-viscosity, the air permeability is suppressed and the water dispersibility is also deteriorated, thus the object of the present invention can not be achieved (see Comparative Example 5).

1. A water-dispersible sheet comprising a papermaking fiber and an alkalized fibrous carboxyalkyl cellulose and further comprising a carboxyalkyl cellulose salt, wherein the degree of etherification of the fibrous carboxyalkyl cellulose is 0.2 to 0.6, the degree of etherification of the carboxyalkyl cellulose salt is 0.5 to 1.6, the viscosity of 1% aqueous solution of the carboxyalkyl cellulose salt measured by Brookfield viscometer is 2 to 200 mPa-s, and the ratio of the carboxyalkyl cellulose salt to the sum of the papermaking fibers and the alkalized fibrous carboxyalkyl cellulose is 0.1 to 10% by weight.

2. The water-dispersible sheet of claim 1, wherein the Canadian standard freeness of the papermaking fiber is 200 to 750 ml CSF.

3. The water-dispersible sheet of claim 1, wherein a tacky adhesive layer is installed on one of the surfaces.

4. The water-dispersible sheet of claim 3, wherein a thermosensitive recording layer is installed on the surface of the sheet opposite to the surface on which the tacky adhesive layer is installed.

5. The water-dispersible sheet of claim 3, wherein an aqueous coating material is applied on the surface of the sheet opposite to the surface on which the tacky adhesive layer is installed.

6. A method for preparing the water-dispersible sheet of claim 1, wherein the method comprises:
(1) preparing a sheet with a papermaking raw material comprising papermaking fibers and fibrous carboxyalkyl cellulose, and
(2) applying an alkalinizing agent on the papermaking raw material obtained in step (1), and
(3) applying a carboxyalkyl cellulose salt on the papermaking raw material obtained in step (2)
or
(2′) applying a carboxyalkyl cellulose salt on the papermaking raw material obtained in step (1); and
(3′) applying an alkalinizing agent on the papermaking raw material obtained in the step (2′).

7. The method of claim 6, wherein the steps (2) and (3) are performed simultaneously, or the steps (2′) and (3′) are performed simultaneously.

8. The method of claim 6, further comprising the step of installing a tacky adhesive layer on one of the surfaces of the water-dispersible sheet.

9. The method of claim 8, further comprising the step of applying an aqueous coating material on the surface of the water-dispersible sheet opposite to the surface on which the tacky adhesive layer is installed.

10. The method of claim 8, further comprising the step of installing a thermosensitive recording layer on the surface of the water-dispersible sheet opposite to the surface on which the tacky adhesive layer is installed.

11. The water-dispersible sheet of claim 2, wherein a tacky adhesive layer is installed on one of the surfaces.

12. The water-dispersible sheet of claim 11, wherein a thermosensitive recording layer is installed on the surface of the sheet opposite to the surface on which the tacky adhesive layer is installed.

13. The water-dispersible sheet of claim 11, wherein an aqueous coating material is applied on the surface of the sheet opposite to the surface on which the tacky adhesive layer is installed.

14. A method for preparing the water-dispersible sheet of claim 2, wherein the method comprises:
(1) preparing a sheet with a papermaking raw material comprising papermaking fibers and fibrous carboxyalkyl cellulose,
and
(2) applying an alkalinizing agent on the papermaking raw material obtained in step (1), and
(3) applying a carboxyalkyl cellulose salt on the papermaking raw material obtained in step (2)
or
(2′) applying a carboxyalkyl cellulose salt on the papermaking raw material obtained in step (1); and
(3′) applying an alkalinizing agent on the papermaking raw material obtained in the step (2′).

15. The method of claim 14, wherein the steps (2) and (3) are performed simultaneously, or the steps (2′) and (3′) are performed simultaneously.

16. The method of claim 15, further comprising the step of installing a tacky adhesive layer on one of the surfaces of the water-dispersible sheet.

17. The method of claim 14, further comprising the step of installing a tacky adhesive layer on one of the surfaces of the water-dispersible sheet.

18. The method of claim 17, further comprising the step of applying an aqueous coating material on the surface of the water-dispersible sheet opposite to the surface on which the tacky adhesive layer is installed.

19. The method of claim 16, further comprising the step of applying an aqueous coating material on the surface of the water-dispersible sheet opposite to the surface on which the tacky adhesive layer is installed.

20. The method of claim 16, further comprising the step of installing a thermosensitive recording layer on the surface of the water-dispersible sheet opposite to the surface on which the tacky adhesive layer is installed.
